(19) United States
(12) Patent Application Publication
(10) Pub. No.: US 2005/0139316 A1
(43) Pub. Date: Jun. 30, 2005

(54) Installation and process for continuous and intermittent production of laminates, with a multi-stage press

(76) Inventor: Aldo Stabile, Crema (IT)

Correspondence Address: Striker Striker & Stenby, 103 East Neck Road, Huntington, NY, 11743, US

(21) Appl. No.: 10/503,863

(22) PCT Filed: Mar. 1, 2002
(86) PCT No.: PCT/IT02/00128

(30) Foreign Application Priority Data
Feb. 26, 2002 (IT) MI2002A000374

(51) Int. Cl. B32B 31/20

(52) U.S. Cl. 156/307.7; 156/311; 156/361; 156/379.8; 156/543; 156/583.1

(57) ABSTRACT

Installation (10) and process for continuous and intermittent production of laminates F,G by means of a composite band (162) obtained from strips of various components (80, 90, 120-127) of the laminate, in a multi-stage press (11) that presents a production cycle all stages of which, of equal duration, are distributed among the various stages 1-5, there being effected in each stage a phase subsequent to that effected in the preceding stage by means of movement, at the end of each phase, of the composite band (162) from one stage to the next, production time for each laminate F, G corresponding to the time taken by the production cycle divided by the number of stages 1-5.

The invention concerns continuous installations for producing laminates of various materials.

Pressing and heating installations, used for sticking together two-dimensional elements of various kinds to obtain products possessing specific technical characteristics (thickness, dimensions, mechanical resistance, appearance), required for numerous structural compositions, are in common use.

The evolution of technology and of materials has been such that it is now possible to produce laminates of every kind, laminates made of paper, plastic, resin-impregnated fabrics, wood, rubber, multi-compositions.

In order to generate the physical phenomena of pressure and heat, essential for lamination, “hot” presses are used, namely, those able to generate pressure and heat at the same time.

Multi-plate presses have been designed for the purpose of reducing costs and to be used for a pile of packages of the material to be pressed and heated, each package, separated by a thick sheet of steel, becoming a laminate at each processing cycle.

While pressure is substantially applied in an equal degree to each package of the pile put into the press, considerable difficulties are encountered over providing an even amount of heat, by conduction from the heated plates, both horizontally and vertically, to all the packages in the pile and to all their components.

Not only does this mean that the height of the pile of packages must be limited but also that the processing cycle must be appreciably lengthened so that the difference in temperature between one package and another is not such as adversely to affect the result, namely the high quality of the product.

To make up for a consequently lower rate of productivity, increasingly larger presses have been built to obtain the highest possible quantity per m² of laminates per cycle.

With the same aim of lowering costs, little by little the press has been replaced by real integrated installations including not only the press but also areas and structures for preparing packages, moving them, loading and later unloading the press, dividing up packages, washing and brushing the steel separation sheets.

Alternative systems have been designed to obtain continuous transformation of a composite band, namely one comprising strips of different materials to be stuck together, into a laminate, subjecting the composite band to heat and pressure during its passage through a suitably sized press.

Results have however been unsatisfactory especially as regards the quality of the product due to complexity of the system involved. The invention here described permits a considerably greater output while ensuring maximum precision and quality of the product as will now be explained.

Subject of the invention is an installation and process for continuous and intermittent production of laminates, including multi-layer laminates of plastic material, using a press with fixed lower plates and movable upper plates, and a composite band comprising all the components of the laminate.

The press is multi-stage and executes a work cycle, the various phases, of equal length, being distributed among the stages of the press, each stage carrying out a phase following that done in the preceding stage, the composite band being moved, at the end of each phase, from one stage to another.

When operating at its steady rate, production of each laminate takes a time corresponding to that of the work cycle divided by the number of stages.

The fixed and movable plates of the press work together in the various stages.

The composite band comprises several strips of pre-preg associated to a copper strip on one or on both faces of said composite band.

The different stages are aligned to allow easy transfer of the composite band from one stage to another.

Constant levels of pressure and heat are generated in the stages of the press, the heat being applied so as to produce the following effects on the fractions of the composite band subjected to the specific phases of the cycle in the different stages:
a rise in temperature, in the fraction undergoing the first phase of the cycle in the first stage of the press, from ambient to that needed for determining, by means of a catalyst, the chemical reaction required to stick the components of the composite band together;
a rise in the first-stage temperature, in the fraction undergoing the second phase of the cycle in the second stage, sufficient to polymerize the resin;
maintenance of the temperature, reached in the preceding stages, in the fractions undergoing subsequent phases in the subsequent stages of the press, to stabilize the effects of polymerization and obtain the desired laminate;
maintenance of pressure without heat in the fraction undergoing the subsequent phase in a subsequent stage, to allow the laminate to cool.

The composite band, even if partially transformed into laminate, can be intermittently moved along inside the multi-stage press, by means of a metal band of high electrical conductivity that, unwinding from a reel upstream of the press and winding onto a reel downstream, practically covers the entire upper surface of the fixed lower plate, said metal band supporting the product, little by little transformed from a composite band into a cold laminate ready for use.

The metal band is preferably of aluminium.

The heat needed for carrying out the phases in the stages of the press, is generated, through Joule effect, by means of the metal band that maintains contact with the electrodes for producing electric current placed at both ends of each stage.

Electric power from the generator at each stage is calculated so as to produce a specific temperature, for the phase concerned, in the fraction of the composite band present in any one stage.

The pre-preg and copper strips are fed in from reels.

The metal band for heating and carrying forward the laminates is fed from and received by the respective reels.

All the reels are run by electric motors whose times and speeds are programmed and controlled by an electronic processor which, by coordinating the specific feed rates of the strips and bands, not only ensures precise disposition and coordination of times and speeds but also makes the correct adjustments to the tensions of the pre-preg and copper strips, coordinated with the tension created by the metal laminate-carrying band to ensure the optimum cycle of movement for each one.

When production makes it possible, the composite band can be heated in all the stages by a single generator that connects two electrodes placed at the beginning and end of the several stages. This single generator can be programmed to associate its effects with the specific generators for each stage.

In one type of execution the press comprises four heating stages, temperature of the composite band being raised in the first stage from ambient to about 130° C.; in the second stage temperature of the fraction of composite band transferred from the first stage rises to about 180° C.; in the third and fourth stages temperature in the fractions of composite band transferred from the preceding stages is maintained at about 180° there being comprised a cooling stage to lower the temperature of the fraction of composite band transferred in that stage, to about 40°.

Advantageously the installation can have four pairs of reels for eight strips of pre-preg and a pair of reels for two copper strips to make a composite band with eight strips of pre-preg and two of copper.

Alternatively the composite band in the various stages can be heated independently of the metal band, by a device chosen from among the possible electric, steam and gas heating devices. This device can advantageously be mounted in the plates of the press.

The press preferably comprises 5 stages each 2.5 m long.

As the production cycle is divided into phases carried out simultaneously in each stage, if total cycle time is 20 minutes, there will be a laminate output of 2.5 m every four minutes.

In one variant of the installation, upstream of the press there is a flat surface on which to slide a group, here called the lower group, of composite band components making it possible to lay a series of multi-layer laminates on said lower group.

Due to movement of the composite band, a group, here called the upper group, of the other components of said composite band is deposited on said lower group, so creating a regular cycle of production of multi-layer laminates in the way already described.

Characteristics and purposes of the invention will be made still clearer by the following examples of its execution illustrated by diagrammatically drawn figures.

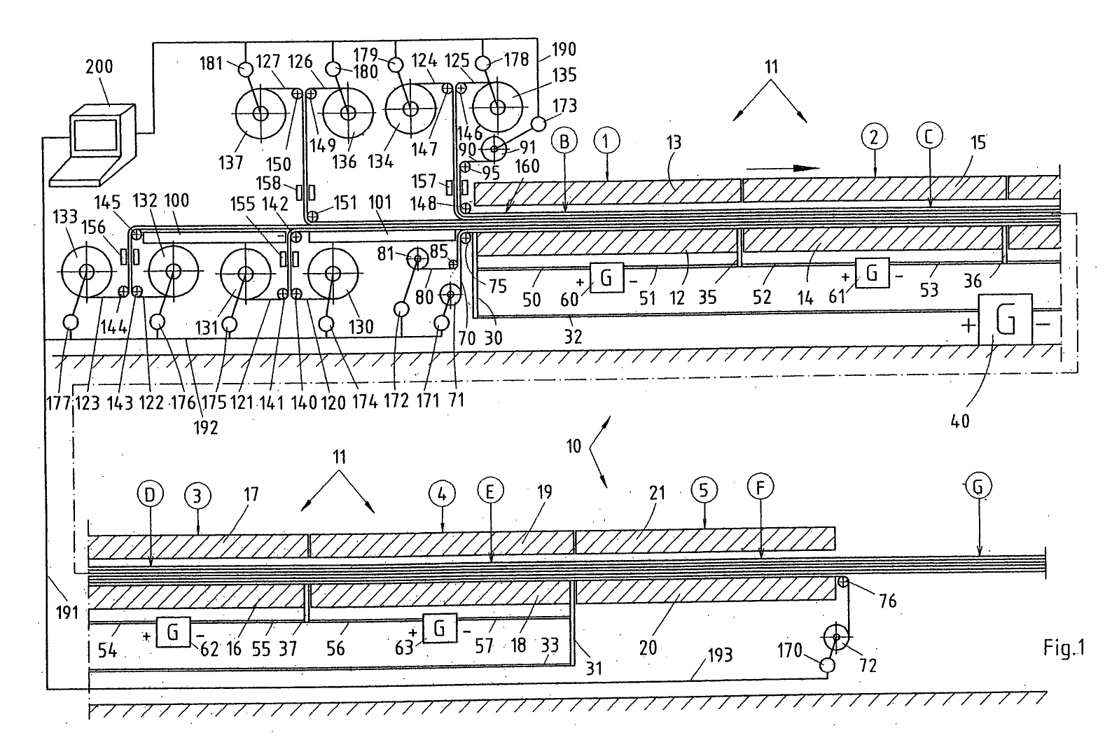

FIG. 1 Continuous installation with a multi-stage press for plastic laminates, seen open, at the end of a cycle, longitudinal section.

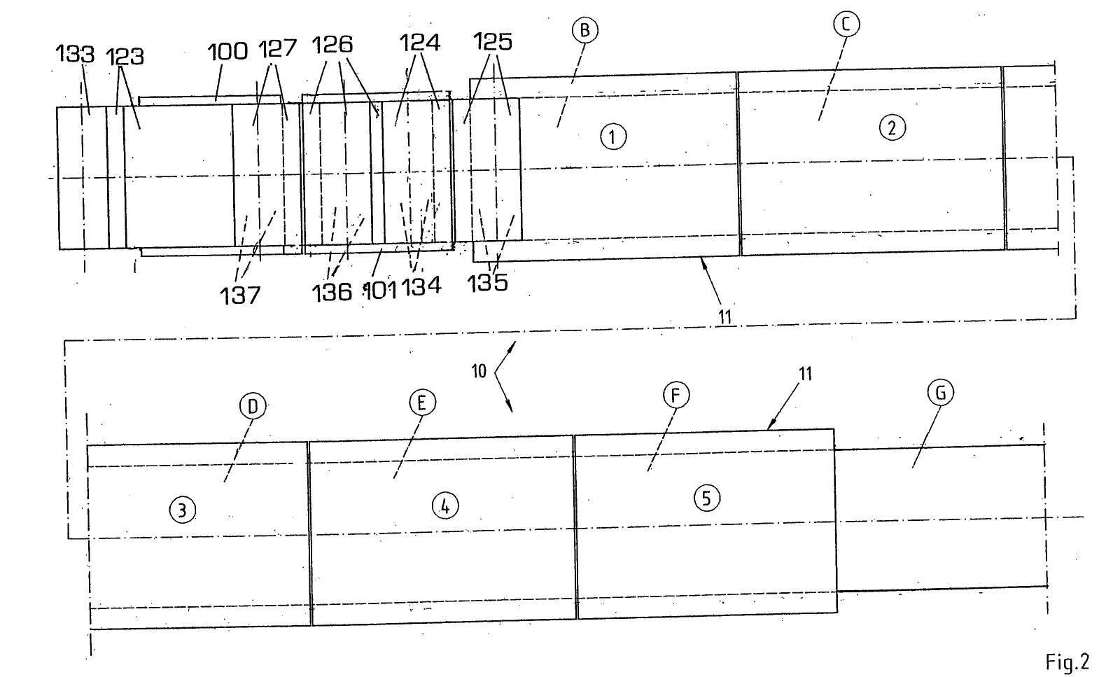

FIG. 2 Plan view of the above.

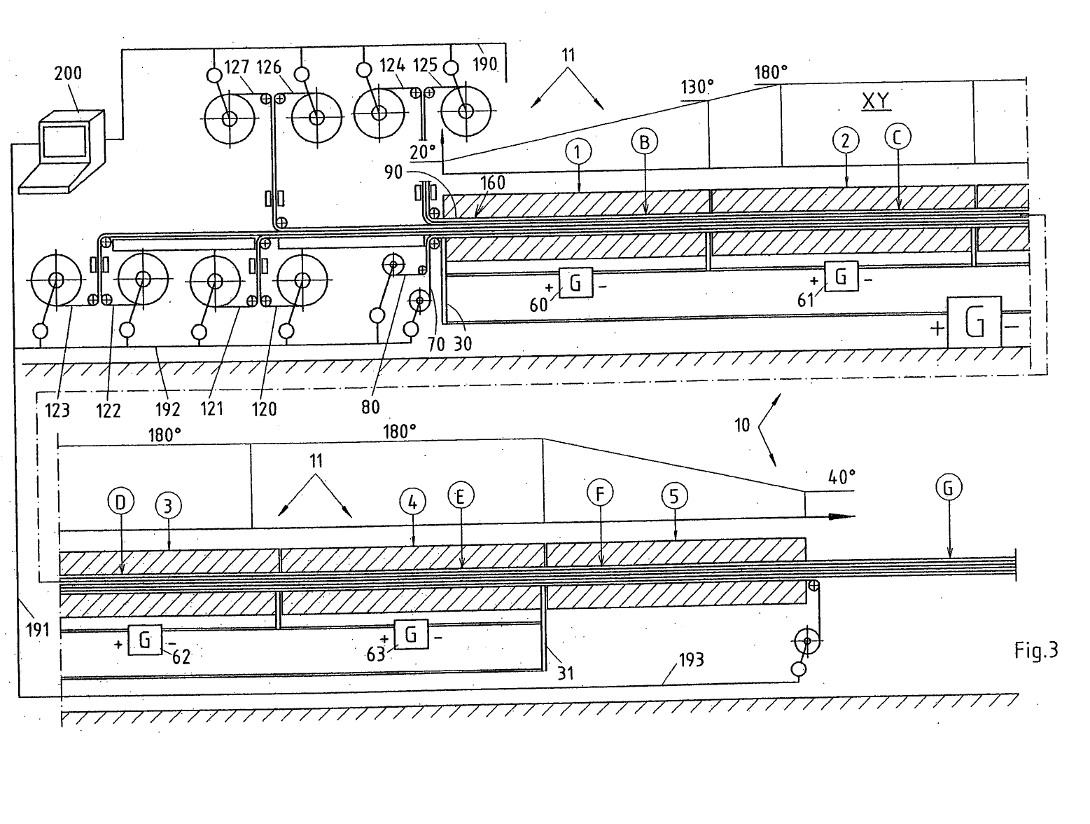

FIG. 3 Installation with the press closed during a fresh cycle with a diagram of temperatures in the various stages, longitudinal section.

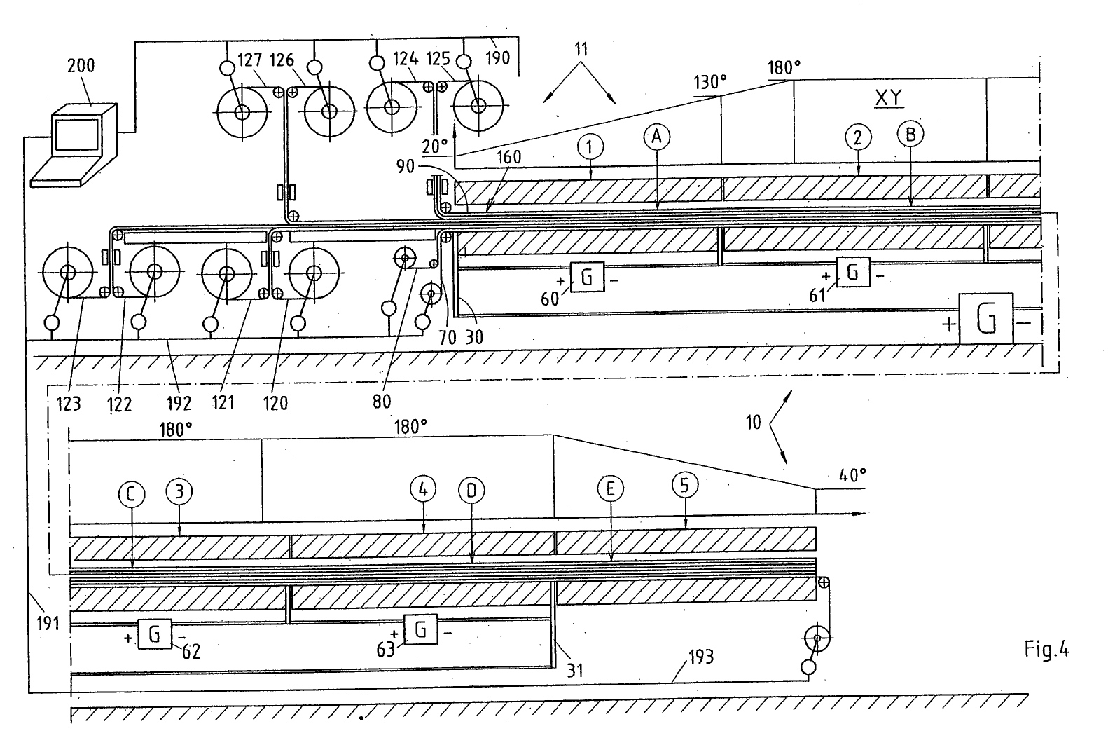

FIG. 4 Installation with the multi-stage press at the end of the new cycle, open, after the fractions of composite band have moved from one stage to the next for starting a fresh cycle, longitudinal section.

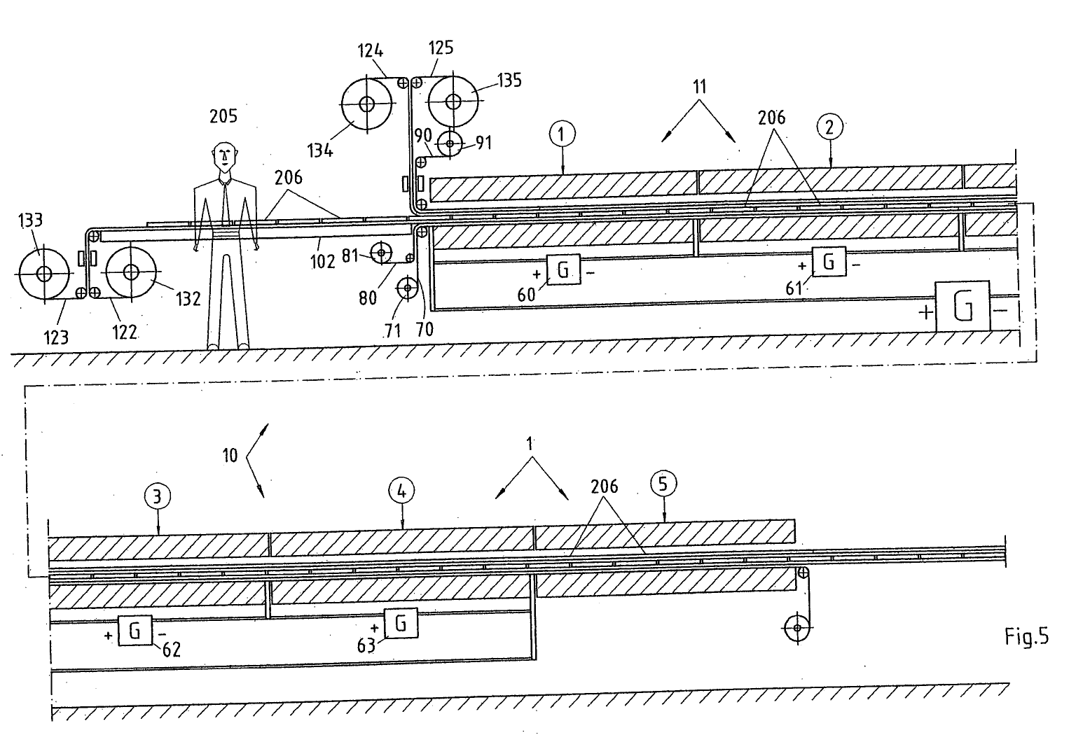

FIG. 5 Installation showing the multi-stage press, in the variant for multi-layer plastic laminates, open at the end of a cycle, longitudinal section.

The installation 10 comprises the multi-stage press 11 with five stages 1 to 5 formed by pairs of fixed and movable aligned plates, respectively 1 (12-13), 2 (14-15), 3 (16-17), 4 (18-19), 5 (20-21). At the longitudinal ends of the group of fixed plates are the electrodes 30 and 31 connected by wires 32 and 33 to the generator 40 of electric current.

At the two ends of the group of fixed plates 12, 14, 16, 18, 20 are the electrodes 35-37.

Electrodes 30 and 35 are connected to the generator 60 of electric current by the wires 50 and 51.

Electrodes 35 and 36 are connected to the generator 61 of electric current by wires 52 and 53.

Electrodes 36 and 37 are connected to generator 62 of electric current by wires 54 and 55.

Electrodes 37 and 31 are connected to the generator 63 of electric current by wires 56 and 57.

On the upper level common to the fixed lower plates 12, 14, 16, 18, 20 the aluminium band 70 can slide in the direction indicated by the arrows, unwinding from the reel 71 and winding onto the reel 72, through cylindrical transmissions 75 and 76, driven by the electric motor 170 and maintaining electrical contact with the top of the electrodes 30, 35-37, 31.

The copper strip 80, fed in from reel 81 through transmission cylinder 85, lies on said aluminium band 70.

Substantially at the level of said copper strip 80 lying inside the press 11, and upstream of the press there is a structure comprising coplanar slide surfaces 100 and 101.

The composite band 160, sliding partly on said surfaces 100 and 101, coming to rest on said copper strip 80, consists of the following pairs of pre-preg bands:
a pair of strips 120 and 121 that unwind from the lower reels, respectively 130 and 131, guided by the cylindrical transmissions 140-142;
a pair of strips 122 and 123 that unwind from the lower reels respectively 132 and 133 guided by cylindrical transmissions 143-145;
a pair of strips 124 and 125 that unwind from the upper reels respectively 134 and 135 guided by cylindrical transmissions 146-148;
a pair of strips 126 and 127 that unwind from the upper reels respectively 136 and 137 guided by cylindrical transmissions 149-151.

The copper strip 90, fed in from the reel 91 and guided by the cylindrical transmission 95, rests on said strip 125 of pre-preg. Adherence between the pre-preg strips in each pair is assured by heating devices 155-158.

It follows that the composite band 160, comprising the pre-preg strips and the copper strips on both faces, can slide inside the press drawn along by the aluminium band 70.

Reels 71 and 72 for the aluminium band 70, reels 130-137 for the strips of pre-preg, and reels 81,91 for the copper strips, are respectively driven by motors 170-181.

These motors are programmed and operated through wires 190-193 from the processor 200 so as to avoid any anomalous tension in the strips of pre-preg and of copper when unwinding in syntony with movement of the aluminium band 70 which draws along the composite band 160 and therefore the laminates, produced by said band at each production cycle, as well.

FIGS. 1 and 2 illustrate a phase of the installation corresponding to the end of a cycle that has generated the plastic laminate G, ready to be picked up.

To begin a new cycle the press must obviously be closed as illustrated in FIG. 3.

At each cycle the fractions B-F of the composite band 160 move from one stage to the next so as to distribute the various phases of the cycle in a substantially even manner among the stages 1-5.

In said FIG. 3, indication XY is given, at the top of the press, of the temperatures of fractions B-F of said composite band 160 respectively corresponding to stages 1-5 indicated in the abcissae of the diagram.

Temperature of the composite band 160 at entry to the press (FIG. 3) may be taken as ambient temperature, presumably 20° C. Power of the electricity generators 60-63, respectively corresponding to press stages 1-5 and therefore to fractions B, E of the composite band 160, is set so that during each cycle, at a stable level of operation, it will be found that:
in the first fraction B, there is an increase of about 130° C. in temperature from ambient level (assumed at 20° C.). At 130° a catalyst is activated that causes a chemical reaction among the components of fraction B of the composite band;
in the second stage 2, transfer has been made from stage 1 of fraction C of the composite band that, due to the effect of the preceding cycle, presents said temperature of 130°, raising it to about 180° causing polymerization of the resin;
in the third stage 3, fraction D of the composite band, transferred from stage 2 at a temperature of 180°, is kept at that temperature;
in the fourth stage 4, the temperature of fraction E, transferred from stage 3 at a temperature of 180°, is kept at that tempreature so producing the plastic laminate;
in the fifth stage 5, the fraction F transferred from stage 4 at 180°, is allowed to cool down to about 40° C.;
the plastic laminate constituted by fraction G of the composite band, that was transferred from stage 5 and therefore already cool (see FIG. 1), can be removed.

From the foregoing it is clear that, as the phases of the cycle are carried out simultaneously in the various stages of the press for heating and cooling, the time required for the entire production cycle is divided by the number of stages.

If the total cycle time is 20 minutes, a laminate will be produced every 4 minutes (20+5).

FIG. 4 illustrates a new cycle, substantially identical with the previous one, except for movement of the composite band 160, and therefore of all its fractions B, C, D, E of one stage, for entry of a new fraction A of composite band, and for removal of fraction F (completed plastic laminate).

FIG. 5 shows a variant of the press suited to production of multi-layer plastic laminates. The levels 100 and 101 are replaced by a single one 102 while the reels of pre-preg strips are limited to a lower pair 132, 133 of strips 122, 123 and to an upper pair 134, 135 with strips 124,125.

During closure of the press, the operator 205 can lay a set of multi-layer laminates 206 in two rows on the pair of strips 122 and 123. It will therefore be seen that at the start of a fresh cycle, the above mullti-layer laminates 206 will be drawn inside the multi-stage press 11 by the lower pair of pre-preg strips 122 and 123 and inserted between said pair associated to the copper strip 70 and the upper pair of pre-preg strips 124 and 125 associated to the copper strip 90.

The cycle inside the press is carried out as already described.

The invention offers evident advantages.

Pressure and heat can be generated by two completely distinct entities:
the plates that generate pressure,
the electrothermic devices that generate heat.

Pressure is exerted by the plates of the press on the composite band while heat can be supplied by a thin lamina of material of high electrical conductivity which, inserted between the lower plate of the press and the laminate with electric current passing through it, Generates diffused heat due to the Joule effect.

In a cold press only a small part near to the laminate can be heated. The “division” of time needed for the cycle, namely passing from composite band to laminate, in several stages respectively used for increasing the temperature of the material from ambient to that of reaction, initiated by a catalyst, from that of reaction to that of polymerization and on to cooling of the laminate produced, utilizing in one stage the phase completed in the preceding stage, means an enormous saving of time even while achieving a product of very high quality.

The heating cycle, applied to one laminate at a time, is very quick especially in the case of plastic laminates.

The single-plate, multi-stage cold press can be much wider and longer, at equivalent cost, than present hot presses.

As the press can be fed off reels, the costly and bulky means now used for separating the packages in the pile can be eliminated, together with related equipment for loading, unloading, cleaning etc.

Feeding in material off reels, so making the press “continuous” even though intermittent, makes it possible to carry out all phases in sequence with simple automatic devices and few operators. Materials enter the press off reels and cut and finished laminates leave it.

To summarise the advantages, the process described above makes possible a very high output of top quality at costs for investment and operation much lower than those possible at present.

1. Installation (10) and process for continuous and intermittent production of laminates including laminates (F, G) of multi-layer plastic material, using a press (11) having fixed lower plates (12, 14, 16, 18, 20) and movable upper plates (13, 15, 17, 19, 21) and using a composite band (160) formed of component strips (80, 90, 120-127),
characterized in that the press (11) is multi-stage and presents a production cycle with all phases, of equal duration, distributed among the various stages 1-5, one phase being carried out in each stage subsequent to that carried out in the preceding stage and, at the end of each phase, movement of the-composite band (160) from one stage to another, so that production of each laminate, when the press operates at a steady rate, is executed in a length of time corresponding to that of the production cycle divided by the number of stages.

2. Installation (10) as in claim 1, characterized in that both the fixed plates (12, 14, 16, 18, 20) and the movable plates (13, 15, 17, 19, 21) of the press act together in the various stages.

3. Installation (10) as in claim 1, characterized in that the various stages 1-5 are aligned to permit easy transfer of the composite band (160) from one stage to another.

4. Installation (10) as in claim 1, characterized in that intermittent transfer of the composite band (160), even if partially transformed into laminate inside the multi-stage press (10), is made by its being drawn along by a metal band (70) of high electric conductivity that unwinds from a reel (71) upstream of the press (11) and, winding onto a reel (72) downstream, substantially covers the entire upper level of the fixed lower plate (12, 14, 16, 18, 20), supporting the product little by little transformed from a composite band (160) into a cooled laminate (F, G) ready for use.

5. Installation (10 as in claim 4, characterized in that the above metal band (70) is of aluminium.

6. Installation (10) as in claim 1, characterized in that the heat required for the phases carried out in the various stages of the press (11) is generated by the metal band (70) producing a Joule effect, said band maintaining continuous contact in its passage with the electrodes (30, 31, 35-37) of the generators (60-63) of electric current placed at the two ends of each stage 1-5, electric power from the generator for each stage being so calculated as to determine, in the fraction of composite band (160) in any one stage, a level of temperature specific for the phase in course of execution.

7. Installation (10) as in claim 1, characterized in that the component strips (120-127) are fed in from reels (130-137) and in that the metal band (70) for heating and transporting is fed in and received by respective reels (71, 72).

8. Installation (10) as in claim 1, characterized in that all the reels (70, 71, 81, 91, 130-137) are driven by electric motors (170-181) the times and speeds of which are programmed and operated by an electronic processor (200) that, by coordinating the specific feeds of the bands and strips (70, 80, 120-127) ensures not only precise and coordinated times and speeds but also optimum adjustment of specific levels of tension in each component strip, coordinated with the tension set up by the transporting band (70) to achieve the best cycle of movement for each of the strips (80, 90, 120, 127).

9. Installation (10) as in claim 1 characteized in that, when production permits, the composite band (162) can be heated in all stages 1-5 by a single electric generator (40) that connects two electrodes (30, 31) placed at the beginning and end of the several stages 1-4 and on which electrodes the metal heating and transporting (70) maintains continuous contact.

10. Installation (10) as in claim 6, characterized in that said single generator (40) is programmed in such a way as to associate its own effects with those of the electric generators (60-63) placed at each stage 1-4.

11. Installation (10) as in claim 1, characterized in that the composite band (162) comprises a plurality of pre-preg strips (120-127) associated, on one or on both faces of said composite band to a copper strip (80, 90).

12. Installation (10) as in claim 1, characterized in that, in the various stages constant pressure and heat are generated, heat being generated so as to determine, on the fractions of composite band (162) subjected to the specific phases of the cycle in the stages 1-5, the following effects:
in fraction (A,B), that in the first stage 1 undergoes the first phase of the cycle, a rise in temperature from ambient to that needed for creating, among the components of the composite band (162), by means of the catalyst, the chemical reaction needed to make the components adhere together;
in the fraction, that in the second stage 2 is subjected to the second phase of the cycle, an increase in the temperature determined in the first stage 1, to a level at which the resin becomes polymerized;
in the fractions subjected, in the subsequent stages 3-4, to the successive phases, maintenance of the temperature reached in the preceding stages so as to stabilize the effects of polymerization and produce the desired laminate;
in the fraction subjected, in a subsequent stage 5, to the successive phase, maintenance of the pressure without the aid of heat to permit the laminate (G) obtained to cool down.

13. Installation (10) as in claim 1, characterized in that the press (11) comprises four heating stages 1-4 producing, at the first stage 1, an increase in temperature of the composite band (162) from ambient to about 130° C., at the second stage 2 the increase in temperature of the fraction of composite band (162), transferred from the first stage, to substantially 180°, at the third stage 3 and fourth stage 4 in the fraction of composite band (162), transferred from the preceding stages, maintenance of such temperature at substantially 180°, and comprises a cooling stage 5 for lowering the temperature of fraction (F,G) of composite band (162), transferred to said stage 5, to substantially 40°.

14. Installation (10) as in claim 1, characterized in that the installation (10) is designed for four pairs of reels (130-137) for eight strips (120-127) of pre-preg and a pair of reels (81, 91) for two strips of copper (80, 90) forming a composite band (162) of eight strips (120-127) of pre-preg and two strips (80, 90) of copper.

15. Installation (10) as in claim 1, characterized in that the composite band (162) is heated in the stages 1-4 by a device chosen from among the various possible devices for heating by electricity, steam or gas.

16. Installation (10) as in claim 15, characterized in that the heating device is inserted in the plates of the press.

17. Installation (10) as in claim 1, characterized in that the press (11) comprises five stages 1-5, each 2.5 m long and therefore, the production cycle being divided into phases simultaneously executed in each stage, if the total cycle time is 20 minutes, one laminate 2.5 m long will be produced every 4 minutes.

18. Installation (10) as in claim 1, characterized in that upstream of the press (11) is a slide surface (102) for a group (80, 122, 123), here called the lower group, of components of the composite band (162), said slide surface (102) permitting a set of multi-layer laminates (206) to be deposited on said lower group, and in that, due to movement of the composite band (80, 122-125), the group, here called the upper group of the other components (90, 124, 125) of the composite band, becomes deposited on said lower group (80, 122, 123), so that a proper cycle of production of multi-layer laminates (206) is effected by the method described in the preceding claims.

19. Process for the production of (F, G) laminates by the means described in claim 1.
